(19) United States
(12) Patent Application Publication
(10) Pub. No.: US 2009/0248803 A1
(43) Pub. Date: Oct. 1, 2009

(54) APPARATUS AND METHOD OF ANALYZING SERVICE PROCESSING STATUS

(75) Inventors: Naoki Akaboshi, Kawasaki (JP); Ken Yokoyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/403,135

(22) Filed: Mar. 12, 2009

(30) Foreign Application Priority Data
Mar. 28, 2008 (JP) 2008-087607

(51) Int. Cl. G06F 15/16; G06F 17/30

(52) U.S. Cl. 709/204; 709/224; 707/3; 707/E17.014; 707/E17.044

(57) ABSTRACT

Apparatus for storing information about collected messages in a message storage mechanism includes a mechanism for detecting a request message and for a process suspended as a suspended process request message, a mechanism for referring to a model storage mechanism to search for a transaction model beginning with a message having the same content as that of the suspended process request message and generating a partial model resulting from exclusion of the messages corresponding to the suspended process request message and a suspension message. Also included are a mechanism for extracting a plurality of messages composing an arrangement of messages similar to that of the partial model, and a mechanism for combining a partial transaction information with at least the suspended process request message, to generate suspended transaction information.

### CROSS REFERENCES TO RELATED APPLICATIONS

The present invention contains subject matter related to Japanese Patent Application No. 2008-87607 filed in the Japanese Patent Office on Mar. 28, 2008, the entire contents of which are incorporated herein by reference.

### FIELD

The present invention relates to apparatuses and methods of analyzing service processing statuses in network systems and, more particularly, to an apparatus and method of analyzing a service processing status on the basis of a result of observation of messages exchanged over a network.

### BACKGROUND

Stable operation 24 hours a day is essential for information technology (IT) systems including Web services. Such systems are required to realize not only the 24-hour stable operation but also higher quality of service with the increasing growth of Web businesses. Accordingly, it is important to constantly monitor the quality of service (availability and/or response) which end users are experiencing from the viewpoint of the end users. In this situation, service management tools are provided to keep track of the operation status of the systems.

Various technologies for monitoring the operation statues of systems are applied to the service management tools. Such technologies include a system visualization technology in which messages flowing through a network are captured to analyze which messages are exchanged between servers for every operation and the analysis results are modeled and monitored. With this technology, it is possible to measure the time necessary for each server to perform a process in cooperation with other servers in response to a request from a terminal device.

If the IT systems are overloaded, the servers have lower processing speeds. In such a case, a user might wait for a response and can possibly suspend the request. For example, the user can press a “Pause” button on a browser to suspend the reading of a request to a Web service. When the request to the Web service is suspended, the suspension by the user is indicated to the corresponding Web server as a TCP Reset message. Although the Web server continues the process that has been started to be executed, the Web server does not transmit a response to a client even after the process is completed.

If the suspension process is repetitively instructed by the user during the operation of a system, it is not possible to return the response before an allowable response time set by the user in the system. Accordingly, it is very important to accurately keep track of the status of the pause button that is pressed by the user in terms of the system operation and management.

However, it is not possible to analyze the suspended process with technologies in related art. Even with the system visualization technology described above, it is not possible to detect a partial transaction that has been suspended because the target of the analysis is a transaction that has been completed.

A transaction is assumed in which processes are performed by a Web server in cooperation with an application server and a database server. It is also assumed that the Web server performs the process in response to a request from a client, the application server performs the process in response to a request from the Web server, and the database server performs the process in response to a request from the application server. When a delay occurs in the application server in such a transaction, the user cannot wait for the response and the process can be suspended in response to an instruction from the client. Since no response message is sent from the Web server to the client in this case, no combination of the captured messages forms a completed transaction. Since the message that does not compose the completed transaction is not to be analyzed, it is not possible to determine the cause of the delay in the related art.

### SUMMARY

According to an aspect of the invention, a service-processing-status analyzing apparatus analyzes a service processing status of a network system in which a plurality of servers are connected to each other. The apparatus includes a message storage mechanism, and a message observing mechanism for collecting messages exchanged over a network and storing information about the collected messages in the message storage mechanism. A suspension detecting mechanism searches information about the messages stored in the message storage mechanism for a suspension message that requests suspension of a process to detect the request message for the process suspended by the suspension message as a suspended process request message. A model storage mechanism for storing a transaction model indicating the arrangement of messages exchanged in a plurality of processes executing each transaction, a partial model creating mechanism refers to the model storage mechanism to search for the transaction model beginning with a message having the same content as that of the suspended process request message detected by the suspension detecting mechanism, and generates a partial model resulting from exclusion of the messages corresponding to the suspended process request message and the suspension message from the detected transaction model. A partial-transaction-information generating mechanism extracts a plurality of messages, from messages arranged in a manner similar to the partial model created by the partial model creating mechanism developed from the messages exchanged after the suspended process request message in the message storage mechanism to generate partial transaction information composed of the extracted messages. A suspended-transaction-information storage mechanism, and a suspended-transaction-information generating mechanism combine the partial transaction information generated by the partial-transaction-information generating mechanism with at least the suspended process request message to generate suspended transaction information, and stores the generated suspended transaction information in the suspended-transaction-information storage mechanism.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 illustrates an embodiment;

FIG. 2 illustrates an example of the configuration of a system according to the embodiment;

FIG. 3 is a block diagram showing an example of the hardware configuration of a service-processing-status analyzing apparatus according to the present embodiment;

FIG. 4 is a block diagram showing an example of the functional configuration of the service-processing-status analyzing apparatus;

FIG. 5 illustrates an example of the data structure of a model storage part;

FIG. 6 is a sequence chart showing an example of a cooperative operation defined in a transaction model;

FIG. 7 is a flowchart showing an example of a process of determining a suspended transaction;

FIG. 8 is an exemplary sequence chart of the suspended transaction;

FIG. 9 illustrates an example of the message sequence in a message buffer;

FIG. 10 is a flowchart showing an example of a process of detecting suspension of a transaction;

FIG. 11 illustrates an exemplary message sequence in which a suspension flag is set;

FIG. 12 illustrates an example of a partial model;

FIG. 13 illustrates an outline of partial matching;

FIG. 14 is a flowchart showing an example of a partial matching process;

FIG. 15 illustrates the state of the partial matching when the transaction model is uniquely determined;

FIG. 16 illustrates the state of the partial matching when the transaction model is not uniquely determined;

FIG. 17 illustrates the state of the partial matching in a partial sequence after entire matching;

FIG. 18 illustrates the state of the partial matching when multiple suspended processes occur; and

FIG. 19 is a graph showing an example of the result of transaction analysis.

### DESCRIPTION OF THE PREFERRED EMBODIMENTS

Embodiments of the present invention will herein be described in detail with reference to the attached drawings.

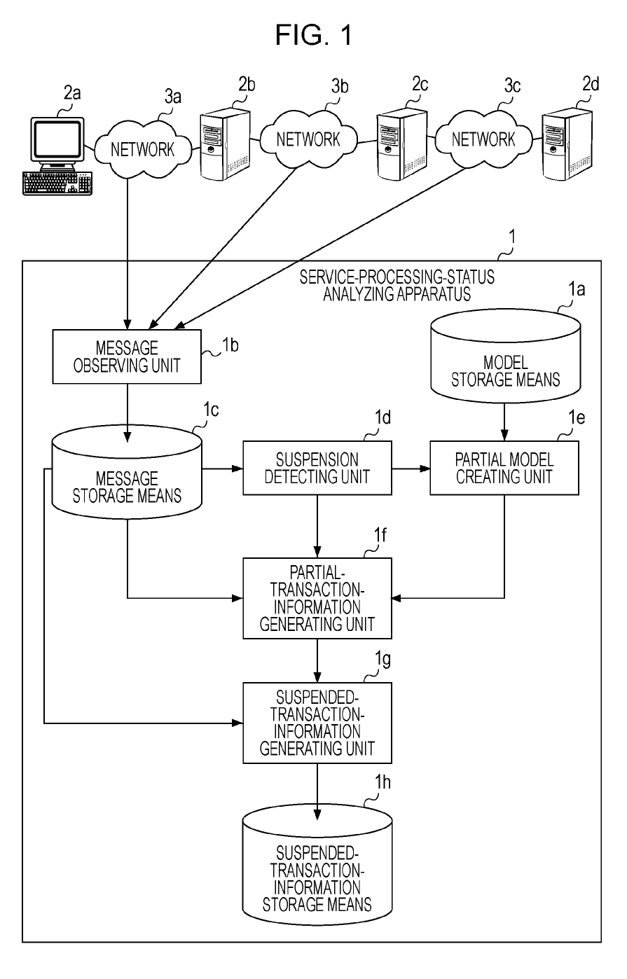

FIG. 1 illustrates an embodiment of the present invention. Referring to FIG. 1, a service-processing-status analyzing apparatus 1 analyzes the processing status of services on the basis of messages exchanged between a client 2a and multiple servers 2b, 2c, and 2d that are connected over networks 3a, 3b, and 3c. The service-processing-status analyzing apparatus 1 includes model storage unit 1a, message observing unit 1b, message storage unit 1c, suspension detecting unit 1d, partial model creating unit 1e, partial-transaction-information generating unit 1f, suspended-transaction-information generating unit 1g, and suspended-transaction-information storage unit 1h in order to analyze the processing status of a transaction that is suspended. These units are typically programmed computers.

The model storage unit 1a stores transaction models indicating the arrangements of messages exchanged in multiple processes executing transactions. The transaction models are stored in advance in the model storage means 1a.

The message observing unit 1b collects messages exchanged over the networks 3a, 3b, and 3c. The message observing unit 1b stores information about the collected messages in the message storage means 1c. The message storage means 1c stores multiple messages.

The suspension detecting unit 1d searches the information about the messages stored in the message storage means 1c for a suspension message to request suspension of a process. The suspension detecting unit 1d detects a request message for the process suspended by the suspension message as a suspended process request message.

The partial model creating unit 1e refers to the model storage means 1a to search for a transaction model beginning with a message having the same content as that of the suspended process request message detected by the suspension detecting unit 1d. The partial model creating unit 1e creates a partial model resulting from exclusion of the messages corresponding to the suspended process request message and the suspension message from the detected transaction model.

The partial-transaction-information generating unit if extracts multiple messages in a message arrangement similar to that of the partial model created by the partial model creating unit 1e, from the messages exchanged after the suspended process request message in the message storage means 1c. The partial-transaction-information generating unit 1f generates partial transaction information composed of the extracted multiple messages.

The suspended-transaction-information generating unit 1g combines the partial transaction information generated by the partial-transaction-information generating unit 1f with at least the suspended process request message to generate suspended transaction information. The suspended-transaction-information generating unit 1g stores the generated suspended transaction information in the suspended-transaction-information storage means 1h. The suspended-transaction-information storage means 1h stores the suspended transaction information.

In the service-processing-status analyzing apparatus 1 described above, the messages exchanged over the networks are collected by the message observing unit 1b and are stored in the message storage means 1c. The suspension detecting unit 1d detects the suspended process request message from the information about the messages stored in the message storage means 1c. The partial model creating unit 1e refers to the model storage means 1a to create the partial model from the transaction model beginning with a message having the same content as that of the suspended process request message. The partial-transaction-information generating unit if generates the partial transaction information composed of the multiple messages composing the message arrangement similar to that of the partial model. The suspended-transaction-information generating unit 1g combines the partial transaction information with at least the suspended process request message to generate the suspended transaction information that is stored in the suspended-transaction-information storage means 1h.

As described above, when the suspended process request message is detected, the partial model of the transaction model is created and the multiple messages composing the message arrangement similar to that of the partial model are extracted from the message storage means 1c. Consequently, it is possible to extract the message arrangement of the suspended transaction information for which the processing has not been completed.

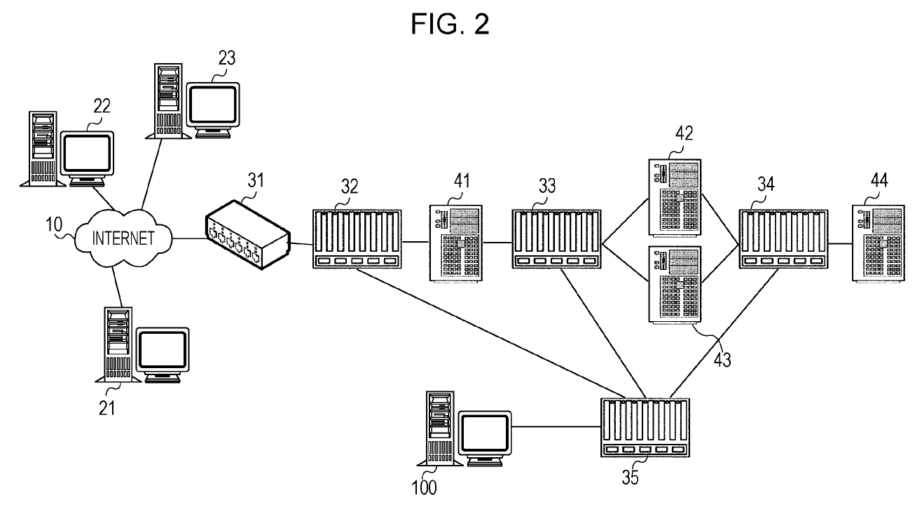

FIG. 2 illustrates an example of the configuration of a system according to the embodiment of the present invention. Referring to FIG. 2, multiple clients 21 to 23 are connected to the Internet 10. A router 31 is also connected to the Internet 10. In the example shown in FIG. 2, the router 31 and the apparatuses on the right side of the router 31 compose a service-providing network system. The service-providing network system has a three-stage configuration including a Web server 41, application servers 42 and 43, and a database (DB) server 44.

The Web server 41 is connected to the router 31 via a switch 32. The Web server 41 provides information to the clients 21 to 23 through World Wide Web (WWW). The application servers 42 and 43 are connected to the Web server 41 via a switch 33. Each of the application servers 42 and 43 performs data processing in response to a request from the Web server 41. The database server 44 is connected to the application servers 42 and 43 via a switch 34. The database server 44 inputs and outputs data in and from the database in response to requests from the application servers 42 and 43.

Each of the switches 32 to 34 has a port monitoring function. The port monitoring function can be used to transmit copies of packets transmitted and received through the ports of the switches 32 to 34 to predetermined ports. A service-processing-status analyzing apparatus 100 is connected to the ports of the switches 32 to 34, through which the copied packets are transmitted, via a switch 35.

The service-processing-status analyzing apparatus 100 analyzes the content of each packet transmitted and received in the service-providing network system to detect a transaction processed by multiple servers. The service-processing-status analyzing apparatus 100 analyzes the time necessary for each server to perform the detected transaction. The service-processing-status analyzing apparatus 100 according to the present embodiment can detect not only the transaction that is completed but also the transaction that is suspended.

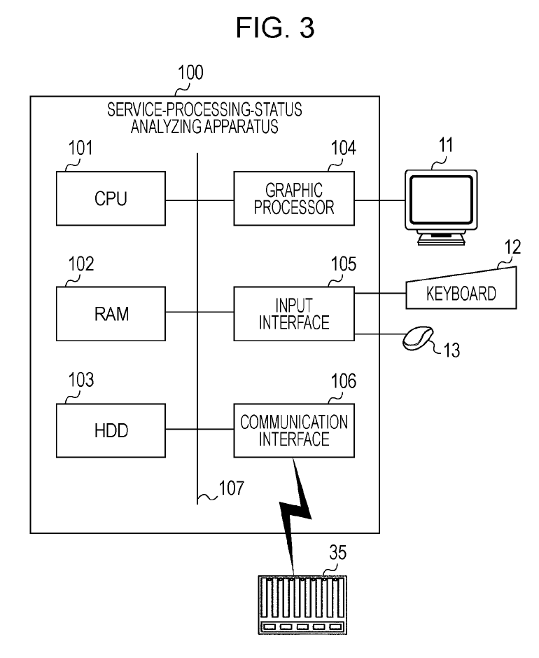

FIG. 3 is a block diagram showing an example of the hardware configuration of the service-processing-status analyzing apparatus according to the present embodiment. Referring to FIG. 3, a central processing unit (CPU) 101 controls the entire service-processing-status analyzing apparatus 100. A random access memory (RAM) 102, a hard disk drive (HDD) 103, a graphic processor 104, an input interface 105, and a communication interface 106 are connected to the CPU 101 via a bus 107.

The RAM 102 is used as a primary storage device of the service-processing-status analyzing apparatus 100. At least part of programs of an operating system (OS) executed by the CPU 101 and application programs is temporarily stored in the RAM 102. A variety of data necessary for the processing in the CPU 101 is also stored in the RAM 102. The HDD 103 is used as a secondary storage device of the service-processing-status analyzing apparatus 100. Programs of the OS, application programs, and a variety of data are stored in the HDD 103. A semiconductor storage device, such as a flash memory, may be used as the secondary storage device.

A monitor 11 is connected to the graphic processor 104. The graphic processor 104 displays an image on the screen of the monitor 11 in response to an instruction from the CPU 101. The monitor 11 is, for example, a display device using a cathode ray tube (CRT) or a liquid crystal display device.

A keyboard 12 and a mouse 13 are connected to the input interface 105. The input interface 105 transmits a signal transmitted from the keyboard 12 or the mouse 13 to the CPU 101 through the bus 107. The mouse 13 is an example of a pointing device and another pointing device may be used instead of the mouse 13. The other pointing device is, for example, a touch panel, a tablet, a touchpad, or a track ball.

The communication interface 106 is connected to the switch 35. The communication interface 106 acquires (captures) packets transmitted and received over the network through the switch 35.

The hardware configuration described above realizes the processing functions of the present embodiment. Although the hardware configuration of the service-processing-status analyzing apparatus 100 is shown in FIG. 3, the clients 21 to 23, the Web server 41, the application servers 42 and 43, and the database server 44 can be realized with hardware configurations similar to that of the service-processing-status analyzing apparatus 100.

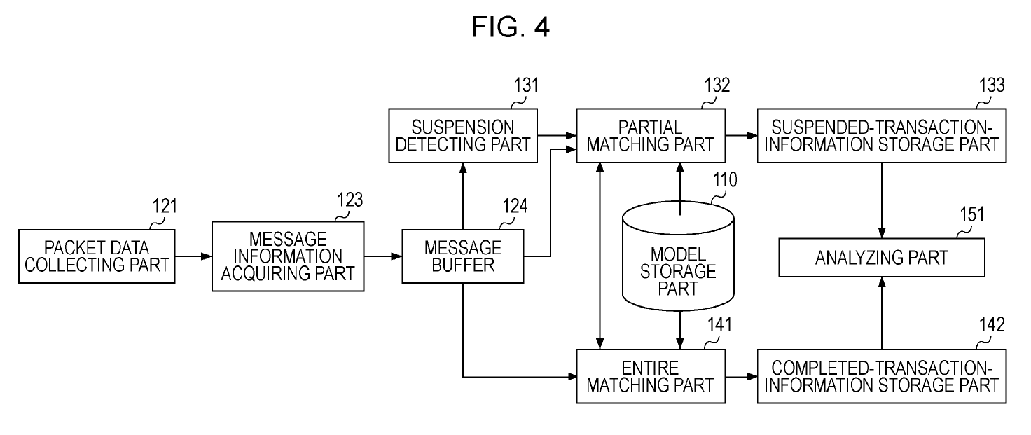

FIG. 4 is a block diagram showing an example of the functional configuration of the service-processing-status analyzing apparatus. Referring to FIG. 4, the service-processing-status analyzing apparatus 100 includes a model storage part 110, a packet data collecting part 121, a message information acquiring part 123, a message buffer 124, a suspension detecting part 131, a partial matching part 132, a suspended-transaction-information storage part 133, an entire matching part 141, a completed-transaction-information storage part 142, and a analyzing part 151.

The model storage part 110 stores a transaction model indicating the combination of messages associated with each transaction. For example, part of the storage area of the HDD 103 is used as the model storage part 110. The transaction model is provided for every type of request output from each client.

The packet data collecting part 121 acquires packets transmitted and received via the switch 35, and passes the acquired packets to the message information acquiring part 123.

The message information acquiring part 123 analyzes the content of each packet passed from the packet data collecting part 121 to detect a message composed of one or more packets. The message information acquiring part 123 stores message data indicating the detected message in the message buffer 124.

The message buffer 124 stores the message data. For example, part of the storage area of the RAM 102 is used as the message buffer 124.

The suspension detecting part 131 searches the messages stored in the message buffer 124 for a message (suspension message) instructing suspension. If the suspension detecting part 131 finds the suspension message, the suspension detecting part 131 notifies the partial matching part 132 of the message data about the request message for the process suspended by the suspension message.

The partial matching part 132 performs partial matching to the suspended transaction on the basis of the request message for the suspended process. Specifically, the partial matching part 132 extracts a transaction model beginning with a message having the same content (for example, using the program having the same Uniform Resource Locator (URL)) as that of the request message for the suspended process from the model storage part 110. Then, the partial matching part 132 sets the remaining part resulting from exclusion of information concerning the messages exchanged with the client from the extracted transaction model as the partial model.

When multiple transaction models beginning with a message having the same content as that of the request message for the suspended process are detected, the partial matching part 132 requests the entire matching part 141 to perform entire matching. In the entire matching, the matching between the transaction that is completed without suspension and the transaction model is performed. The partial matching part 132 excludes the messages in the transaction that is completed from the targets for the partial matching in the entire matching. As a result, the messages in the transaction that is suspended remain as the targets for the partial matching and the message arrangement (partial transaction) partially matching with one of the multiple detected transaction models can be created.

Next, the partial matching part 132 extracts the message arrangement following the partial model from the messages in the message buffer 124. The partial matching part 132 combines the request message for the suspended process and the suspension message with the partial transaction to generate the suspended transaction information indicating the process when the transaction is suspended. The partial matching part 132 stores the suspended transaction information in the suspended-transaction-information storage part 133.

The suspended-transaction-information storage part 133 stores the suspended transaction information. For example, part of the storage area of the RAM 102 is used as the suspended-transaction-information storage part 133.

The entire matching part 141 compares the message data stored in the message buffer 124 with the transaction model stored in the model storage part 110 to detect a combination of messages having the same configuration as that of the transaction model. The entire matching part 141 stores the detected combination of messages in the completed-transaction-information storage part 142 as completed transaction information.

The completed-transaction-information storage part 142 stores the completed transaction information. For example, part of the storage area of the RAM 102 is used as the completed-transaction-information storage part 142.

The analyzing part 151 analyzes, for example, the processing time of each transaction for every server from the suspended transaction information stored in the suspended-transaction-information storage part 133 and the completed transaction information stored in the completed-transaction-information storage part 142. The analyzing part 151 displays the analysis result in the monitor 11 by using, for example, a graph.

The service-processing-status analyzing apparatus 100 having the above functions can detect the combination of messages partially matching with the transaction model, in addition to the combination of messages matching with the entire transaction model, from the message buffer 124 and can analyze the detected combinations. The correspondence between the components shown in FIG. 1 and the components shown in FIG. 4 is as follows:

The model storage means 1a in FIG. 1 corresponds to the model storage part 110 in FIG. 4. The function of the message observing unit 1b in FIG. 1 is realized by the packet data collecting part 121 and the message information acquiring part 123 shown in FIG. 4. The message storage means 1c in FIG. 1 corresponds to the message buffer 124 in FIG. 4. The suspension detecting unit 1d in FIG. 1 corresponds to the suspension detecting part 131 in FIG. 4. The functions of the partial model creating unit 1e, the partial-transaction-information generating unit 1f, and the suspended-transaction-information generating unit 1g in FIG. 1 are included in the partial matching part 132. The suspended-transaction-information storage means 1h in FIG. 1 corresponds to the suspended-transaction-information storage part 133 in FIG. 4.

The transaction models are stored in the model storage part 110 in advance in order to generate the suspended transaction information by using the functions shown in FIG. 4.

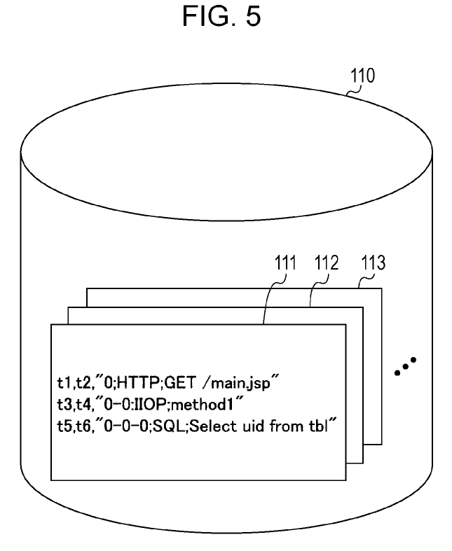

FIG. 5 illustrates an example of the data structure of the model storage part. Referring to FIG. 5, the model storage part 110 stores multiple transaction models 111, 112, 113 . . . . Multiple message information items transmitted and received over the network when the transactions are processed are included in each of the transaction models 111, 112, 113 . . . . The message information items concern request messages to request the processing and response messages indicating the responses to the request messages.

Each message information item is composed of the transmission time of the request message, the transmission time of the response message, and the content of the message (part surrounded by double quotation marks).

The transmission times of the messages in the transaction on which the creation of the transaction model is based are set in the transmission time of the request message and the transmission time of the response message. Specifically, when the transaction model is to be created, the transaction is practically processed in the network system and the messages occurring in the transaction are observed to create the transaction model. Simply, one transaction is processed in the test stage of the network system and the messages occurring in the transaction are observed to determine the combination of messages composing one transaction.

The content of message includes a message type ID indicating the type of the message and the content of the request message. The message type ID has the data structure from which the caller of the message can be identified. Specifically, when the transaction is executed by multiple servers, one server requests another server to process the transaction with the request message. The hierarchical structure of the request of the processing between the servers is indicated in the message type ID.

In the example shown in FIG. 5, the process corresponding to the request message from the client is in a first hierarchy. The process corresponding to the request message to request a process of another server in the execution of the process in the first hierarchy is in a second hierarchy. The process corresponding to the request message output to another server in the execution of the process in the second hierarchy is in a third hierarchy.

A numerical value with which the process in the first hierarchy can be identified is set in the message type ID concerning the request message to request the process in the first hierarchy. A pair of the message type ID corresponding to the process in the caller and a numerical value that can be identified between the request messages output from the process in the caller is set in the message type ID concerning the request message to request the process in the second hierarchy. A pair of the message type ID corresponding to the process in the caller and a numerical value that can be identified between the request messages output from the process in the caller is set in the message type ID concerning the request message to request the process in the third hierarchy.

The protocol name and the content of processing are included in the content of the request message. The protocol name of the message, such as HyperText Transfer Protocol (HTTP), Internet Inter-Object Request Broker (ORB) Protocol (IIOP), or Structured Query Language (SQL), is set as the protocol name. The content of processing requested of the server that has received the request message (for example, information used for identifying the program executing the process or a parameter necessary for the processing) is set as the content of processing.

For example, three message information items are included in the transaction model 111. The message information in the first line is “t1,t2,“0;HTTP;GET/main.jsp” in which “t1” indicates that the request message is transmitted at “t1”, “t2” indicates that the response message is transmitted at “t2”, and “0” in “0;HTTP;GET/main.jsp” denotes the message type ID. Since this message type ID does not include a value indicating the process of the requester, the process is requested from the client. That is, the request message is sent to request the process in the first hierarchy. The “HTTP” in “0;HTTP;GET/main.jsp” indicates that the message is according to the HTTP. The “GET/main.jsp” in “0;HTTP;GET/main.jsp” denotes the content of processing.

The message information in the second line is “t3,t4,“0-0:IIOP;method1” in which “t3” indicates that the request message is transmitted at “t3”, “t4” indicates that the response message is transmitted at “t4”, and “0-0” in “0-0:IIOP;method1” denotes the message type ID. Since this message type ID includes a value “0” (the left value) indicating the process of the requester, the request message is output in the process corresponding to the message type ID “0”. That is, the request message is sent to request the process in the second hierarchy. “IIOP” in “0-0:IIOP;method1” indicates that the message is according to the IIOP. The “method11” in “0-0:IIOP;method1” denotes the content of processing.

The message information in the third line is “t5,t6,“0-0-0;SQL;Select uid from tbl” in which “t5” indicates that the request message is transmitted at “t5”, “t6” indicates that the response message is transmitted at “t6”, and “0-0-0” in “0-0-0;SQL;Select uid from tbl” denotes the message type ID. Since this message type ID includes values “0” (the left and middle values) indicating the process of the requester, the request message is output in the process corresponding to the message type ID “0-0”. That is, the request message is sent to request the process in the third hierarchy. “SQL” in “0-0-0;SQL;Select uid from tbl” indicates that the message is according to the SQL operating a relational database (RDB). The “Select uid from tbl” in “0-0-0;SQL;Select uid from tbl” denotes the content of processing.

The relationship between the times t1, t2, t3, t4, t5, and t6 is “t1<t3<t5<t6<t4<t2”. When the matching between the transaction model 111 and the acquired messages is performed, the temporal relationship between the transmission times of the messages should coincide with that in the transaction model 111.

Such transaction models 111, 112, 113, . . . define the cooperative operation between the servers in response to the request message from the client.

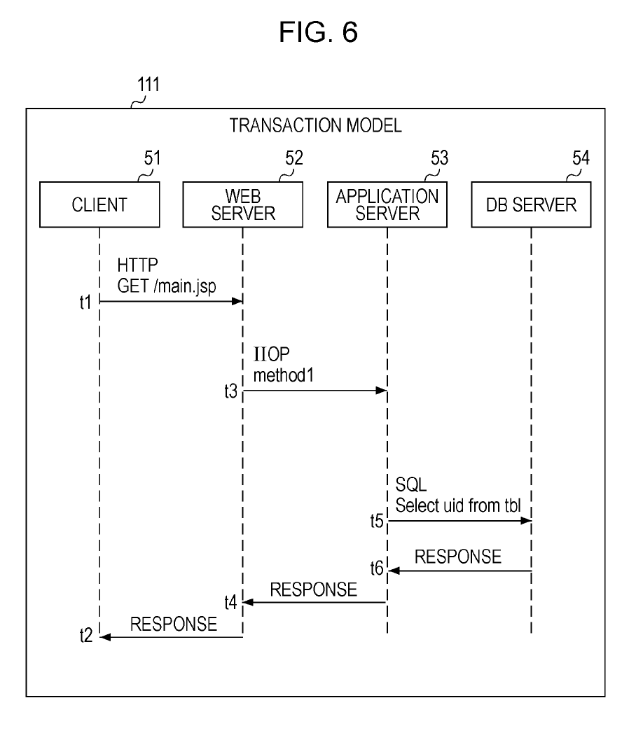

FIG. 6 is a sequence chart showing an example of the cooperative operation defined in the transaction model. The cooperative operation defined in the transaction model 111 in FIG. 5 is shown in FIG. 6, in which a client 51, a Web server 52, an application server 53, and a database server 54 communicate with each other. The client 51, the Web server 52, the application server 53, and the database server 54 do not indicate specified positions but indicate arbitrary apparatuses provided with the corresponding processing functions.

In the transaction model 111, the client 51 transmits the request message according to the HTTP to the Web server 52 at “t1”. The Web server 52 transmits the request message according to the IIOP to the application server 53 at “t3”. The application server 53 transmits the request message according to the SQL to the database server 54 at “t5”.

When the processing in the database server 54 is completed, the database server 54 transmits the response message according to the SQL to the application server 53 at “t6”. When the processing in the application server 53 is completed, the application server 53 transmits the response message according to the IIOP to the Web server 52 at “t4”. When the processing in the Web server 52 is completed, the Web server 52 transmits the response message according to the HTTP to the client 51 at “t2”.

The operation of the network system is started with the transaction models 111, 112, 113, . . . stored in the model storage part 110 in advance. When the transaction is suspended during the operation of the network system, it is determined which transaction model the suspended transaction corresponds to.

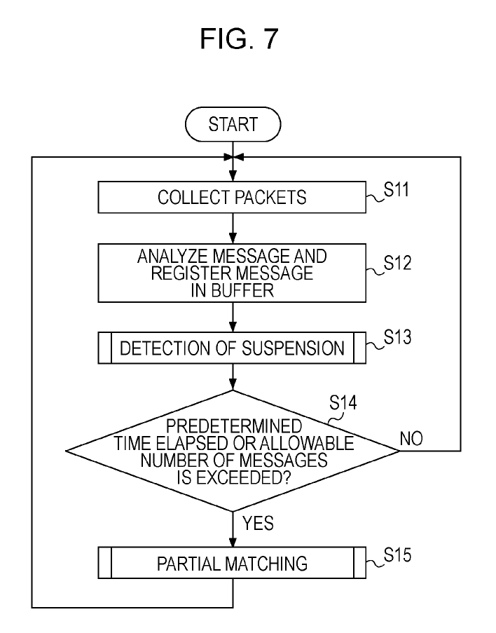

FIG. 7 is a flowchart showing an example of a process of determining the suspended transaction. The process shown in FIG. 7 will now be described in the order of step numbers.

In Step S11, the packet data collecting part 121 collects packets on the network. Specifically, when a transaction occurs, messages are input and output in and from each server. Each message is divided into packets that are transmitted over the network. The packets are collected by the packet data collecting part 121. When the packet data collecting part 121 acquires the packets, the packet data collecting part 121 adds the acquisition time (time stamp) to each of the acquired packets. The packets to which the time stamps are added are passed to the message information acquiring part 123.

In Step S12, the message information acquiring part 123 analyzes the messages and registers the analyzed messages in the message buffer 124. Specifically, the message information acquiring part 123 includes a packet data buffer in which the acquired packets are stored. Part of the storage area of the RAM 102 is used as the packet data buffer.

The message information acquiring part 123 recomposes a session from the acquired packets. The process of recomposing a session will now be described on the assumption that the packets are Internet Protocol (IP) packets.

The message information acquiring part 123 sorts the multiple packets for every session to which the packets belong. Specifically, the message information acquiring part 123 acquires the transmission and reception IP addresses from the IP header of each packet. The message information acquiring part 123 acquires the transmission port number and the reception port number from the Transmission Control protocol (TCP) header of the packet. The message information acquiring part 123 uses the set of the acquired four values as a session identifier. A unique number may be assigned to the session identifier. The message information acquiring part 123 generates the identifier of each packet and sorts the packets having the same session identifier as the packets transmitted in the same session.

The message information acquiring part 123 extracts certain data from the packets sorted in each session to recompose a pair of messages (a pair of a request message and a response message). Specifically, the message information acquiring part 123 reads the flag included in the TCP header of each packet to acquire a session state, such as start, establishment, or disconnection. For example, the message information acquiring part 123 recognizes start of the session through detection of a packet having a Synchronize Flag (SYN) set to “1” and recognizes establishment of the session through detection of a response having an Acknowledgement Flag (ACK) set to “1” to the packet. After the data transmission and the response having the ACK set to “1” are repetitively performed in the state in which the session is established, the message information acquiring part 123 recognizes disconnection of the session through detection of a packet having a Fin Flag (FIN) set to The IP address of each server may be indicated to the message information acquiring part 123 in advance. In this case, the message information acquiring part 123 can determine the transmission direction of each packet from the pair of the IP addresses.

The message information acquiring part 123 reads out the transmission port number from the IP header of each packet when the server address is included in the transmission addresses, or reads out the reception port address therefrom when the server address is included in the reception addresses. The message information acquiring part 123 can use the port number as the identifier to determine which service the session concerns. For example, when the port number of the server is “80”, the message information acquiring part 123 determines that the communication (HTTP) with the Web server is established.

The session is recomposed in the above manner. After the session is recomposed, the message information acquiring part 123 recomposes the message from the data segments of the packets sorted in each session. Specifically, the message information acquiring part 123 extracts the data segments from the collection of packets transmitted and received in the same session and arranges the extracted data segments. The message information acquiring part 123 divides the sequence of the arranged data segments into segments each having the message size according to the format of the protocol to recompose the message. When the message is divided into multiple segments and the message divided into the multiple segments is transmitted, the message information acquiring part 123 combines the multiple data segments to compose one message. When the multiple combined messages are transmitted in one data segment, the message information acquiring part 123 cuts out the multiple messages from the single data segment.

The message can be recomposed in the above manner. The message information acquiring part 123 stores the recomposed messages in the message buffer 124 in time series. The storage of the messages in the message buffer 124 in time series creates the message sequence in the message buffer 124. A pair of messages that have transmission directions opposite to each other and that are in the same session, among the messages included in the message sequence, is recognized as a message pair. Whether the messages are in the same session is determined from the identity of the IP addresses of the message at the transmission and reception sides and of the port numbers. The message information acquiring part 123 sets the processing time for the response message to the message pair. The processing time means the difference between the time indicated in the time stamp of the request message and the time indicated in the time stamp of the response message.

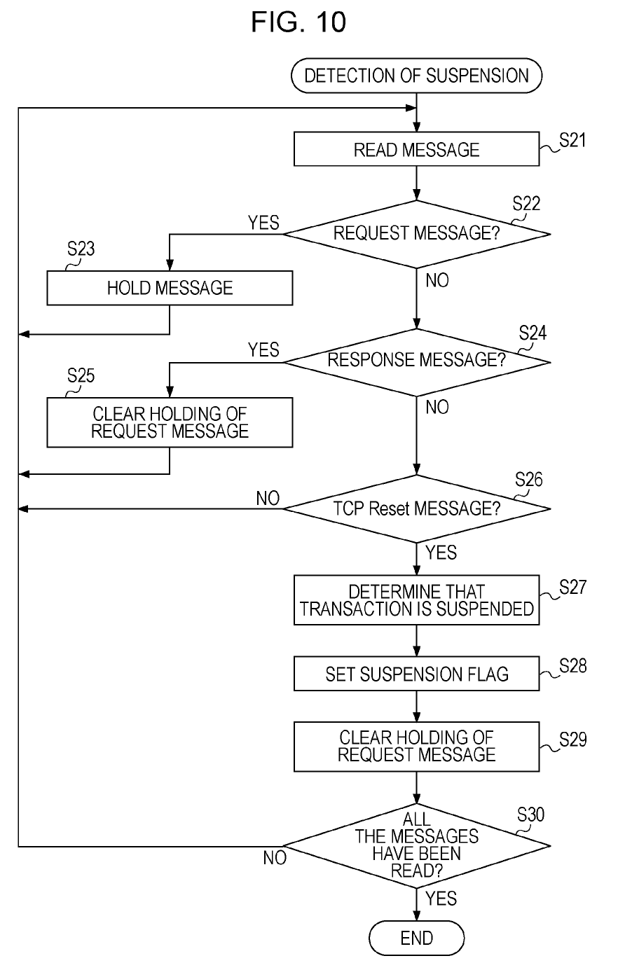

Referring back to FIG. 7, in Step S13, the suspension detecting part 131 detects suspension of the transaction. The detection of the suspension of the transaction will be described in detail below with reference to FIG. 10.

In Step S14, the partial matching part 132 determines whether a predetermined time elapsed (a predetermined partial matching period expired) since the previous partial matching has been performed or whether the number of messages stored in the message buffer 124 exceeds a predetermined allowable number of messages. If either of the conditions is met, the process proceeds to Step S15. If none of the conditions is met, the process goes back to Step S11 to continue the collection of the packets.

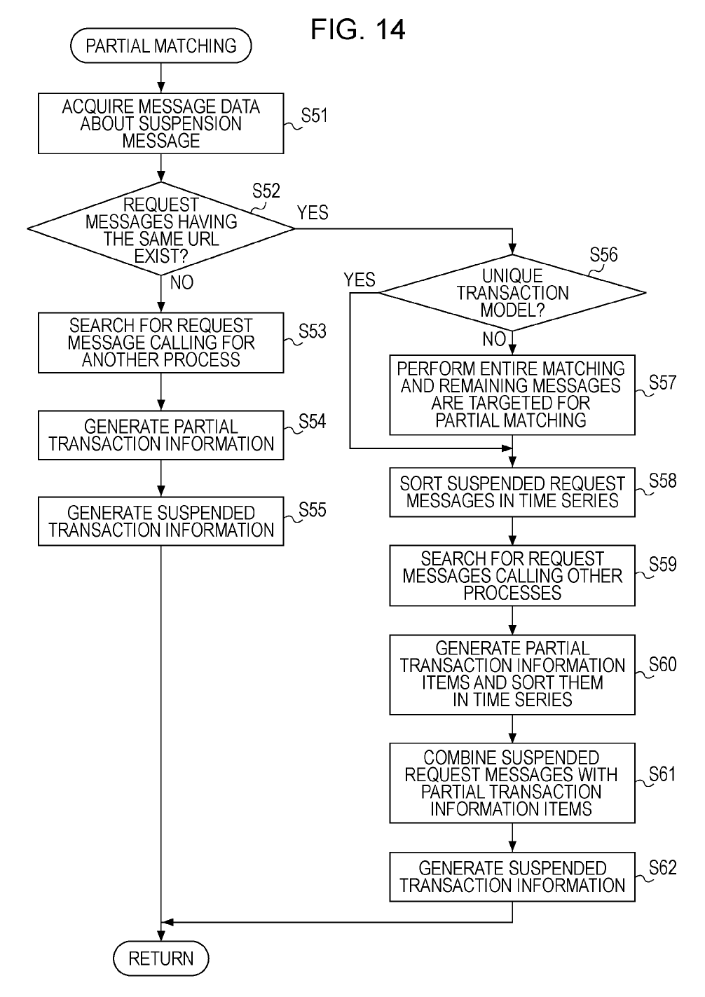

In Step S15, the partial matching part 132 executes the partial matching. The partial matching will be described in detail below with reference to FIG. 14.

It is assumed here that the transaction is suspended. The message sequence generated at this time will now be described.

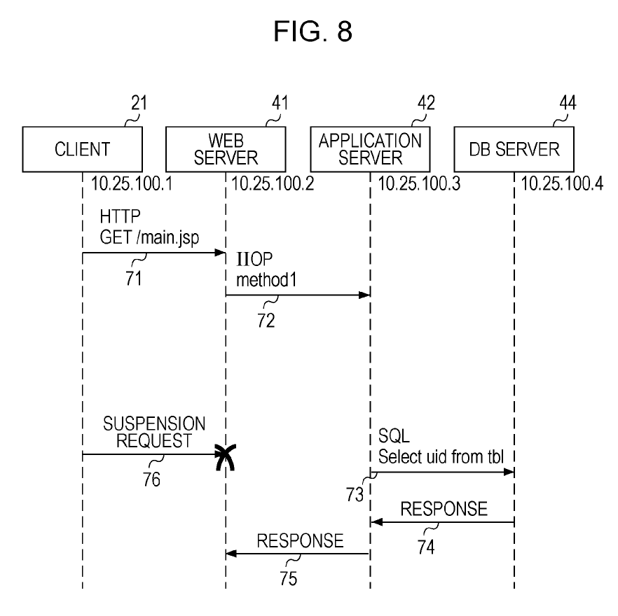

FIG. 8 is an exemplary sequence chart of a suspended transaction. In the example in FIG. 8, the client 21 transmits a request message 71 according to the HTTP to the Web server 41. The Web server 41 transmits a request message 72 according to the IIOP to the application server 42 in the process in response to the received request message 71 according to the HTTP. The application server 42 transmits a request message 73 according to the SQL to the database server 44 in the process in response to the received request message 72 according to the IIOP.

The database server 44 executes the process in response to the request message 73 transmitted from the application server 42 and transmits a response message 74 to the application server 42. The application server 42 completes the process in response to the request message 72 transmitted from the Web server 41 and transmits a response message 75 to the Web server 41.

A user of the client 21 performs a suspension operation without waiting for a response from the Web server 41. As a result, the client 21 transmits a suspension request 76 to the Web server 41.

After the series of transaction processes are performed, the messages making up the transaction are stored in the message buffer 124 in time series. It is assumed here that the IP address of the client 21 is “10.25.100.1”, the IP address of the Web server 41 is “10.25.100.2”, the IP address of the application server 42 is “10.25.100.3”, and the IP address of the database server 44 is “10.25.100.4”.

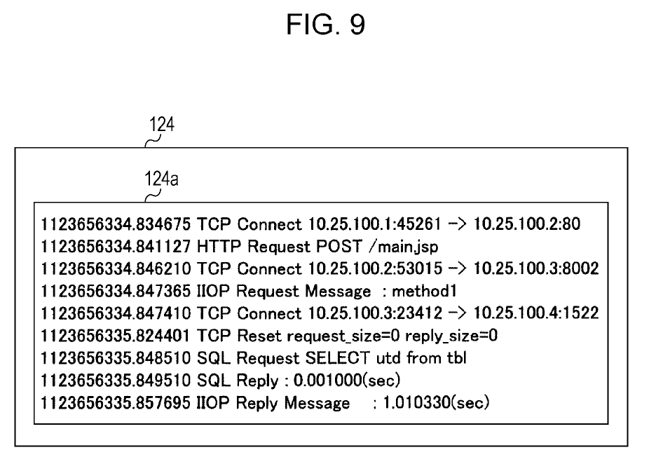

FIG. 9 illustrates an example of the message sequence in the message buffer. In the example in FIG. 9, a message sequence 124a is stored in the message buffer 124. Multiple message data items are stored in the message sequence 124a in time series.

The time stamp indicating a time in UNIX (registered trademark) format (a time elapsed since Jan. 1, 1970) is described at the head of each message data item. When the message is a connection request to establish the session or a suspension request, the session number is added after the time stamp of the message data item.

The protocol name and the content of the message follow the time stamp in each message data item.

In the message sequence 124a shown in FIG. 9, when the communication between apparatuses is started, the TCP connection is established first. For example, the first message in the message sequence 124a indicates that the connection is established between the client 21 and the Web server 41 in response to a request from the client 21. The second message in the message sequence 124a is a request message transmitted from the client 21 to the Web server 41.

In the example shown in FIG. 9, a suspension request (TCP Reset) (in the sixth message) is submitted from the client 21 to the corresponding session before the process corresponding to the second request message in the message sequence 124a is completed. This means that a canceling process is performed in the client 21. The presence of the suspension can be determined from the Reset signal and the session according to the TCP in the TCP/IP communication even if a protocol other than the HTTP is used. In other words, if the Reset signal, instead of the response, is observed after the request in the session, the request is cancelled (because the response should be paired with the request in the synchronous communication). The suspension request is submitted for the process corresponding to the second request message in the message sequence 124a before the process is completed. Accordingly, no response message corresponding to the request message exists.

The suspension detecting part 131 refers to the message sequence 124a to detect the presence of the suspension of the transaction.

FIG. 10 is a flowchart showing an example of the process of detecting suspension of a transaction. The process shown in FIG. 10 will now be described in the order of step numbers.

In Step S21, the suspension detecting part 131 reads one unprocessed message in the message buffer.

In Step S22, the suspension detecting part 131 determines whether the read message is a request message. The message including “Request” in the content thereof is a request message. If the read message is a request message, the process proceeds to Step S23. If the read message is not a request message, the process proceeds to Step S24.

In Step S23, the suspension detecting part 131 holds the request message. Specifically, the suspension detecting part 131 writes the message data about the request message in a certain storage area in the RAM 102. Then, the process goes back to Step S21.

In Step S24, the suspension detecting part 131 determines whether the read message is a response message. If the read message is a response message, the process proceeds to Step S25. If the read message is not a response message, the process proceeds to Step S26.

In Step S25, the suspension detecting part 131 clears the holding of the request message corresponding to the response message (deletes the request message corresponding to the response message from the RAM 102). Then, the process goes back to Step S21.

In Step S26, the suspension detecting part 131 determines whether the message is a TCP Reset message. If the message is a TCP Reset message, the process proceeds to Step S27. If the message is not a TCP Reset message, the program goes back to Step S21.

In Step S27, the suspension detecting part 131 determines that the transaction corresponding to the request message indicated by the message ID held with the session number of the TCP Reset message is suspended. The suspension detecting part 131 passes the message ID of the request message to request the processing of the suspended transaction to the partial matching part 132.

In Step S28, the suspension detecting part 131 identifies the request message to request the processing of the suspended transaction from the message buffer 124 and sets a flag indicating the suspension to the identified request message.

In Step S29, the suspension detecting part 131 clears the holding of the request message to request the processing of the suspended transaction (deletes the request message to request the processing of the suspended transaction from the RAM 102).

In Step S30, the suspension detecting part 131 determines whether all the messages have been read out from the message buffer 124. If all the messages have been read out from the message buffer 124, the process is terminated. If the unread message remains, the process goes back to Step S21.

As the result of the suspension detecting process, the suspension flag is set to the request message for the suspended process in the message sequence 124a in the message buffer 124.

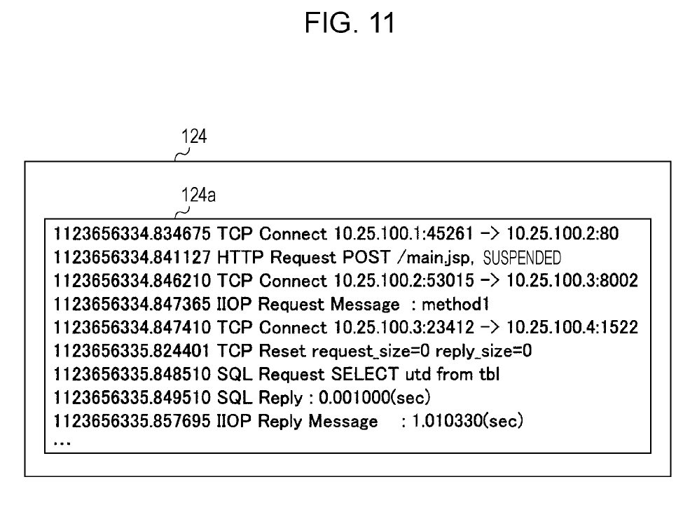

FIG. 11 illustrates an exemplary message sequence in which the suspension flag is set. A description “suspended” (the suspension flag) is added to the end of the second message in the message sequence 124a.

If the suspension is detected, the partial matching part 132 performs the partial matching. In the partial matching, the matching between the suspended transaction and the partial structure (partial model) of the transaction model is determined (the determination of whether the suspended transaction matches with the partial structure (partial model) of the transaction model).

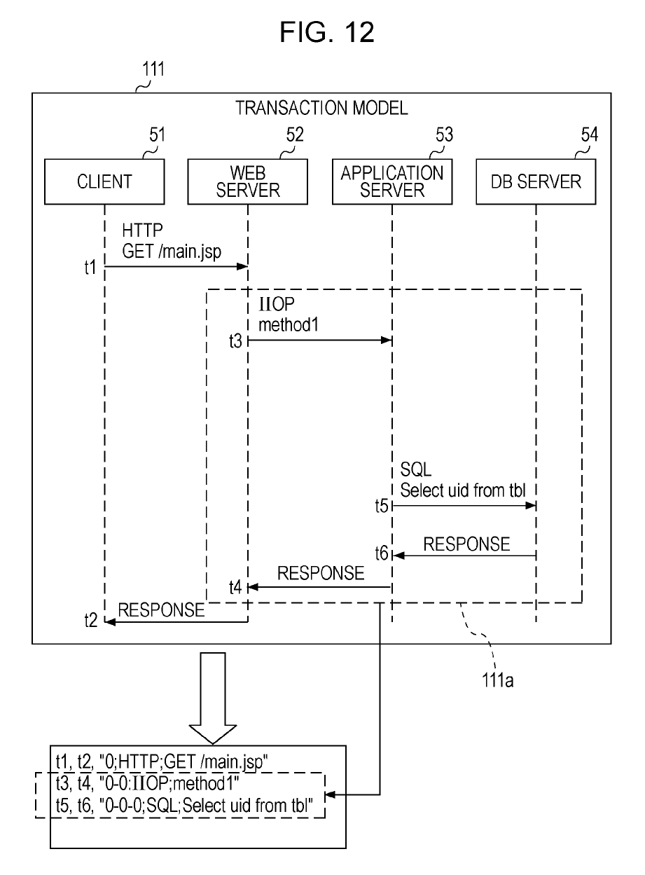

FIG. 12 illustrates an example of the partial model. In the partial matching, not the entire transaction model 111 but the messages resulting from exclusion of the message pair exchanged between the client 51 and the Web server 52 in the transaction model 111 make up a partial model 111a. The partial matching part 132 searches the model storage part 110 for the transaction model 111 including the partial model 111a matching with the suspended transaction.

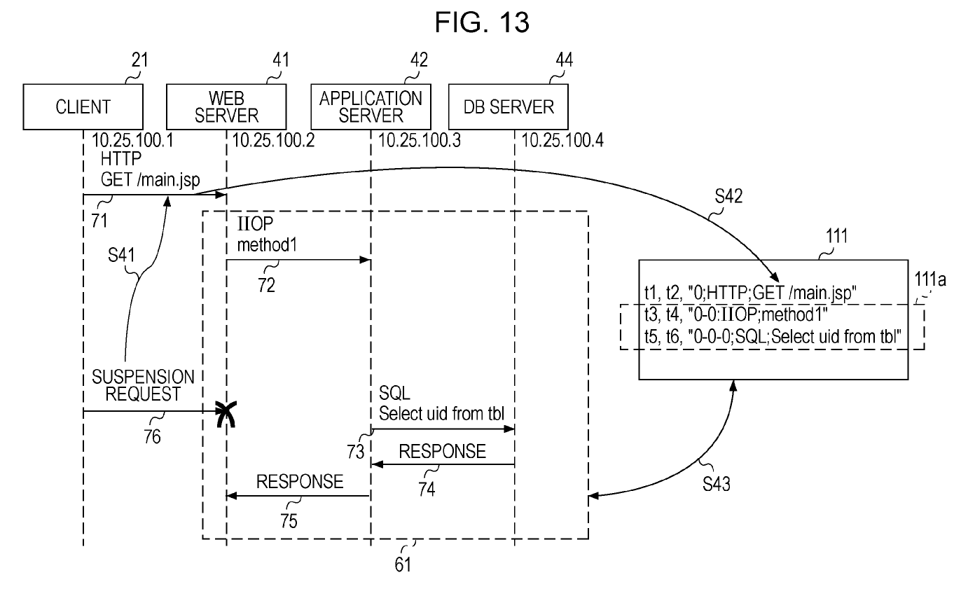

FIG. 13 illustrates an outline of the partial matching. The partial matching part 132 identifies the suspended URL. The suspended URL can be identified by referring to the message sequence 124a to analyze the content of the suspended request message 71 (Step S41).

The partial matching part 132 searches the model storage part 110 for the transaction model 111 in which the suspended URL is set as the URL of the request message 71 (Step S42). The model storage part 110 recognizes the collection of the remaining message information excluding the first message information in the searched transaction model 111 as the partial model 111a.

The partial matching part 132 refers to the message buffer 124 to extract the collection of messages (partial transaction information 61) matching with the partial model 111a from the messages transmitted after the transmission time (time stamp) of the suspended request message 71 (Step S43). In order to realize the matching between the partial model 111a and the partial transaction information 61, it is necessary to match the call relationship of the process performed in response to the request message between the partial model 111a and the partial transaction information 61, to match the content of processing requested by the request message therebetween, and to match the order in which the request messages are output therebetween.

For example, in the first message information in the partial model 111a, the call by the request message according to the IIOP is performed in response to the process called by the request message according to the HTTP. Specifically, the process “method1” is called from the process “GET/main.jsp”.

Accordingly, the partial matching part 132 searches the Web server 41 executing the suspended process for the request message 72 to call the lower process. The request message 72 to call the lower process should be subsequent to the request message 71 and should be transmitted before the suspension request 76. The partial matching part 132 detects the request message 72. The partial matching part 132 searches for the response message 75 corresponding to the request message 72. The partial matching part 132 determines that the pair of the request message 72 and the response message 75 matches with the first message information in the partial model 111a.

In the second message information in the partial model 111a, the call by the request message according to the SQL is performed in response to the process called by the request message according to the IIOP. Specifically, the process “Select uid from tbl” is called from the process “method1”.

Accordingly, the partial matching part 132 searches the Web server 41 executing the process corresponding to the request message 72 according to the IIOP for the request message 73 to call the lower process. The request message 73 to call the lower process should be subsequent to the request message 72 and should be transmitted before the response message 75. The partial matching part 132 detects the request message 73. The partial matching part 132 searches for the response message 74 corresponding to the request message 73. The partial matching part 132 determines that the pair of the request message 73 and the response message 74 matches with the second message information in the partial model 111a.

The partial matching part 132 detects the partial transaction information 61 matching with the partial model 111a in the above manner.

The partial matching in Step S15 in FIG. 7 will now be described in detail with reference to FIG. 14.

FIG. 14 is a flowchart showing an example of the partial matching process. The process shown in FIG. 14 will now be described in the order of step numbers.

In Step S51, the partial matching part 132 acquires message data about the suspension message. Specifically, the partial matching part 132 receives the message data indicating the request message for the suspended process from the suspension detecting part 131. When the multiple suspended processes are detected in the suspension detecting part 131, the partial matching part 132 receives the multiple message data items.

In Step S52, the partial matching part 132 determines whether the request messages for which the same URL is specified are sent in the time range from the start time of the suspended process to the suspension time.

Specifically, when the multiple processes for which the same URL is specified are executed in parallel in the Web server 41, one of the processes can be suspended. In such a case, the request messages to request derived processes are sent from the respective processes executed in parallel in the Web server 41 to the application servers 42 and 43. Accordingly, it is necessary to determine the correspondence between the request messages for the derived processes and the multiple processes in the Web server 41 (at least one process is suspended). If the messages for which the same URL is specified are sent in the time range, the process proceeds to Step S56. If the messages for which the same URL is specified are not sent in the time range, the process proceeds to Step S53.

In Step S53, the partial matching part 132 searches the messages in the message sequence 124a for the request message to call the process derived from the suspended process. The request message to call the process derived from the suspended process should be sent in the time range from the start time of the suspended process (the transmission time of the request message) to the suspension time (the transmission time of the suspension message).

In Step S54, the partial matching part 132 generates partial transaction information beginning with the request message detected in Step S53. Specifically, the partial matching part 132 associates the processes that meet a constraint that the processing time zone of the caller includes the processing time zone of the called apparatus with each other. The partial matching part 132 arranges the request messages and the response messages exchanged between the associated processes in time series and uses them as the partial transaction information.

There is a case where the process in the called apparatus meets the constraint for the processes in the multiple callers. For example, this corresponds to a case where, when two processes are concurrently executed in the Web server 41, the request messages are sent from the Web server 41 to the application server 42 in the processing time zones of both of the two processes, and the response messages are returned in the processing time zones of the processes in both of the callers. In this case, it is not possible to determine which process in the two processes in the caller (the processes in the Web server 41) and the process in the called apparatus (the process in the application server 42) should be associated with only by using the constraint. In this case, the partial matching part 132 performs the association in accordance with the partial model of the transaction model stored in the model storage part 110 in such a case.

The transaction model to be referred to begins with a request message having the same URL as that of the request message for the suspended process. The part resulting from exclusion of the request message from the client and the response message to the client from the transaction model to be referred to corresponds to the partial model. The partial matching part 132 searches the model storage part 110 for the transaction model beginning with a message having the same content (the same URL) as that of the request message for the suspended process. The partial matching part 132 uses the part resulting from exclusion of the first message information in the detected transaction model (the information about the message exchanged with the client) as the partial model. In addition, the partial matching part 132 extracts the messages that have the same call relationship as in the created partial model and that meet the constraint from the message sequence 124a. The partial matching part 132 arranges the extracted messages in time series and uses them as the partial transaction information.

The partial transaction information partially matching with the transaction model is generated in the above manner.

In Step S55, the partial matching part 132 combines the request message for the suspended process, the suspension message, and the partial transaction information generated in Step S54 with each other to generate the suspended transaction information. Then, the partial matching process is terminated.

In Step S56, the partial matching part 132 determines whether the transaction model corresponding to the suspended process is uniquely determined. Specifically, the partial matching part 132 searches the model storage part 110 for the transaction model on the basis of the URL indicated in the request message for the suspended process. If one transaction model is detected as the result of the search, the transaction model is uniquely determined. If multiple transaction models are detected as the result of the search, the unique determination of the transaction model fails. If the transaction model is uniquely determined, the process proceeds to Step S58. If the transaction model is not uniquely determined, the process proceeds to Step S57.

In Step S57, the partial matching part 132 performs the entire matching to the message sequence 124a and targets the remaining messages resulting from exclusion of the messages included in the transaction matching with the transaction model for the partial matching. Specifically, the transaction that is completed without suspension should match with any of the transaction models stored in the model storage part 110. Accordingly, the partial matching part 132 uses the message included in the message sequence 124a to generate the transaction matching with the transaction model. The partial matching part 132 excludes the messages included in the transaction matching with the transaction model from the target for the partial matching. For example, the partial matching part 132 sets a flag indicating that the message is excluded from the target for the partial matching to the message to be excluded from the target for the partial matching in the message buffer 124.

The messages included in the transaction matching with the entire transaction model by the entire matching can be excluded from the target for the partial matching to correctly generate the partial transaction information derived from the suspended process. As a result, it is possible to select the appropriate transaction model even if the multiple transaction models corresponding to the URL indicated in the request message for the suspended process exist.

In Step S58, the partial matching part 132 sorts the suspended request messages in time series.

In Step S59, the partial matching part 132 searches the messages targeted for the processing in the message sequence 124a for the request messages calling the processes derived from the suspended processes. Here, the request messages corresponding to the respective suspended processes are detected.

In Step S60, the partial matching part 132 generates partial transaction information items beginning with the messages detected in Step S59. The partial transaction information items matching with the partial model are generated in the same manner as in Step S54. Here, the multiple partial transaction information items beginning with the respective request messages detected in Step S59 are generated. The partial matching part 132 sorts the partial transaction information items in time series.

In Step S61, the partial matching part 132 associates the suspended request messages sorted in Step S58 with the partial transaction information items sorted in Step S60 in descending order. The partial matching part 132 combines the suspended request messages with the partial transaction information items that are associated with each other.

In Step S62, the partial matching part 132 uses the information items combined in Step S61 as the suspended transaction information. Then, the partial matching process is terminated.

The partial matching is performed in the above manner. Examples of the partial matching will now be described in detail.

First, an example will be described in which the transaction model is uniquely determined on the basis of the URL indicated in the request message for the suspended process.

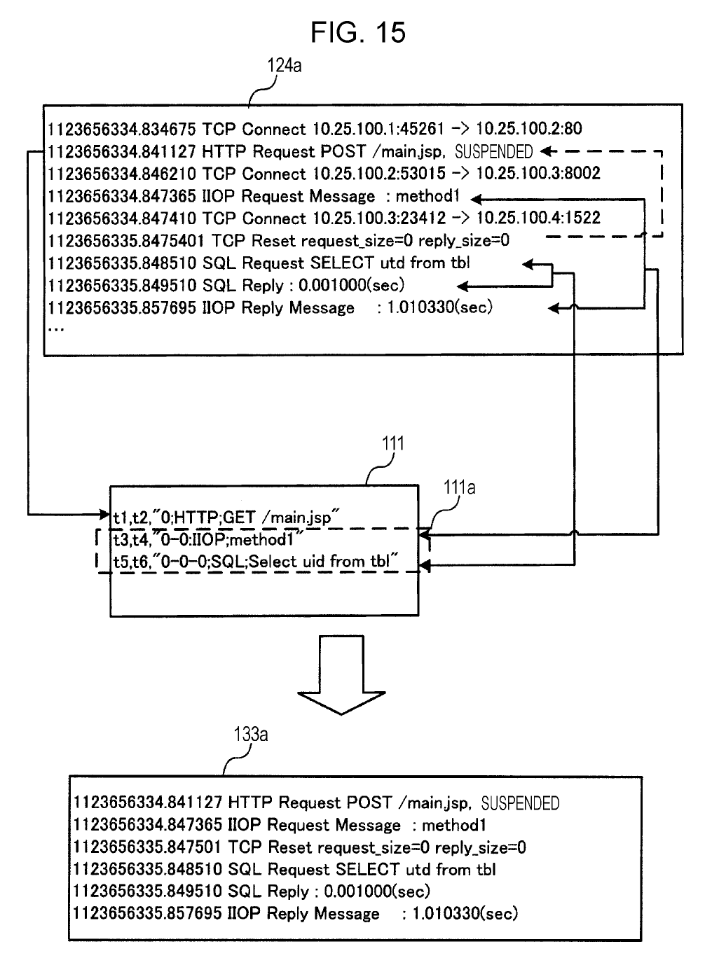

FIG. 15 illustrates the state of the partial matching when the transaction model is uniquely determined. In the message sequence 124a in FIG. 15, the suspension detecting part 131 adds a description “suspended” to the request message for the suspended process. The partial matching part 132 extracts the URL of the request message for the suspended process and searches the model storage part 110 by using the extracted URL. Only the transaction model 111 is detected in the example in FIG. 15.

The partial matching part 132 recognizes the part resulting from exclusion of the first message information from the detected transaction model 111 as the partial model 11la. The partial matching part 132 searches the message sequence 124a for the message pair corresponding to the second message information in the transaction model 111. As the result of the search, the message pair of the fourth message (1123656334.847365 IIOP Request Message:method1) and the ninth message (1123656335.857695 IIOP Reply Message:1.010330(sec)) in the message sequence 124a is detected.

It is necessary to meet the constraint that the processing time zone of the called apparatus is included in the processing time zone of the caller in the entire matching. However, the process corresponding to the request from the client is suspended in the partial matching. Accordingly, the processing time zone of the suspended process does not necessarily include the processing time zone of the called apparatus. Consequently, a constraint that the request message calling another process is sent within the processing time zone (from the start of the process to the suspension thereof) is set for the suspended process in the partial matching. In other words, the response message from the called apparatus may be transmitted after the suspension. The constraint is relaxed in the partial matching, as described above.

When the partial matching part 132 recognizes that the detected fourth message data meets the constraint, the partial matching part 132 searches the message sequence 124a for the message pair corresponding to the third message information in the transaction model 111. As the result of the search, the message pair of the seventh message (1123656335.848510 SQL Request SELECT utd from tbl) and the eighth message (1123656335.849510 SQL Reply:0.001000(sec)) in the message sequence 124a is detected.

The process corresponding to the second message information in the transaction model 111 is completed without suspension. Accordingly, the same constraint as in the entire matching is imposed on other processes called from the completed process. Specifically, the processing time zone of the called apparatus should be included in the processing time zone of the caller. In the example in FIG. 15, the processing time indicated by the message pair of the seventh message data and the eight message data is included in the processing time indicated by the message pair of the fourth message data of the caller and the ninth message data. Accordingly, the constraint is met.

The partial matching part 132 composes suspended transaction information 133a partially matching with the transaction model 111 in the above manner. Specifically, the partial matching part 132 arranges the suspension message, the request message for the suspended request message, and the pair of the request messages that match with the partial model 111a and that are derived from the suspended process in time series, and uses them as the suspended transaction information 133a. The suspended transaction information 133a is stored in the suspended-transaction-information storage part 133.

Next, an example will be described in which the transaction model is not uniquely determined from the URL indicated in the request message for the suspended process.

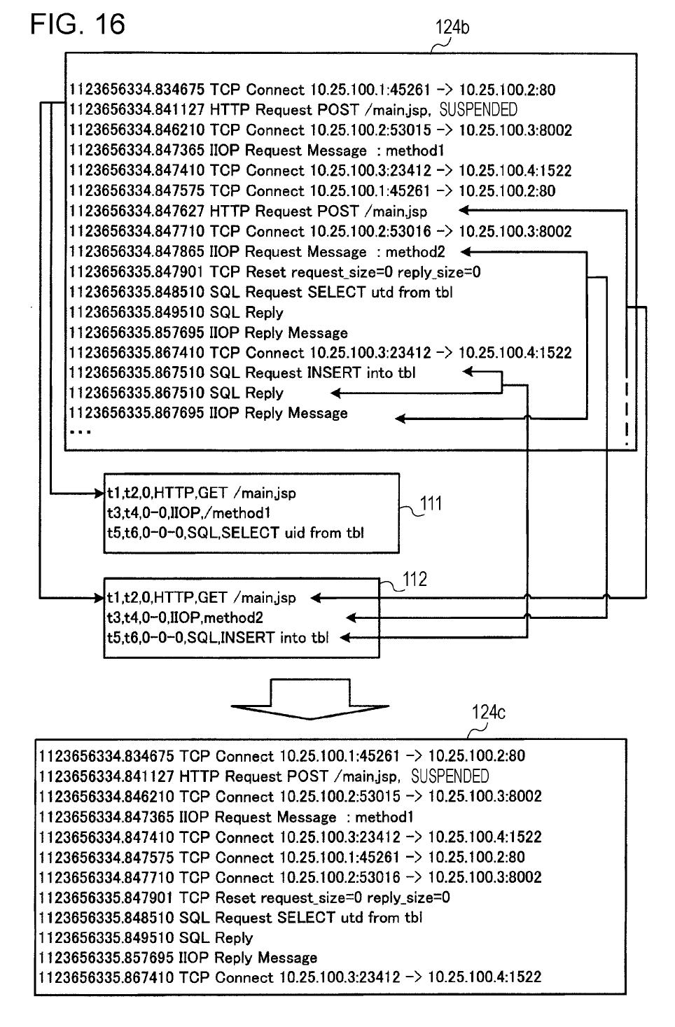

FIG. 16 illustrates the state of the partial matching when the transaction model is not uniquely determined. In the example shown in FIG. 16, when the transaction model is searched for on the basis of the URL indicated in the request message for the suspended process in a message sequence 124b, the two transaction models 111 and 112 are detected. Accordingly, the entire matching is performed before the partial matching. In the entire matching, it is necessary to meet the constraint that the processing time zone of the called apparatus is included in the processing time zone of the caller in all the pairs of the called apparatus and the caller. The transaction corresponding to the transaction model 112 is detected from the message sequence 124b as the result of the entire matching.

A partial sequence 124c resulting from exclusion of the messages included in the detected transaction from the message sequence 124b is targeted for the partial matching.

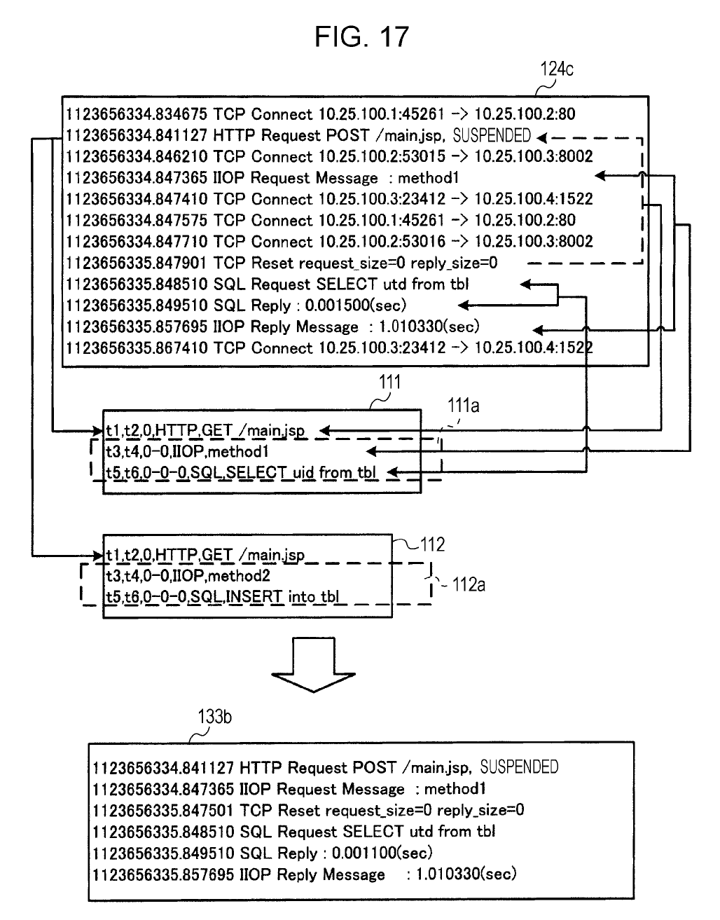

FIG. 17 illustrates the state of the partial matching in the partial sequence after the entire matching. In the example shown in FIG. 17, the two transaction models 111 and 112 are targeted for the matching. The matching creates partial models 111a and 112a resulting from exclusion of the first matching information from the respective transaction models 111 and 112. The partial matching part 132 performs the partial matching between each of the partial models 111a and 112a and the partial sequence 124c.

As the result of the partial matching, as in the partial matching described above with reference to FIG. 15, the partial transaction information matching with the partial model 111a is detected from the partial sequence 124c. In contrast, the partial transaction information matching with the partial model 112a is not detected from the partial sequence 124c. This indicates that the transaction corresponding to the transaction model 112 is suspended. Accordingly, the partial matching part 132 combines the partial transaction information corresponding to the partial model 111a with the request message for the suspended process and the suspension message to generate suspended transaction information 133b.

Next, an example will be described in which multiple suspended processes occur.

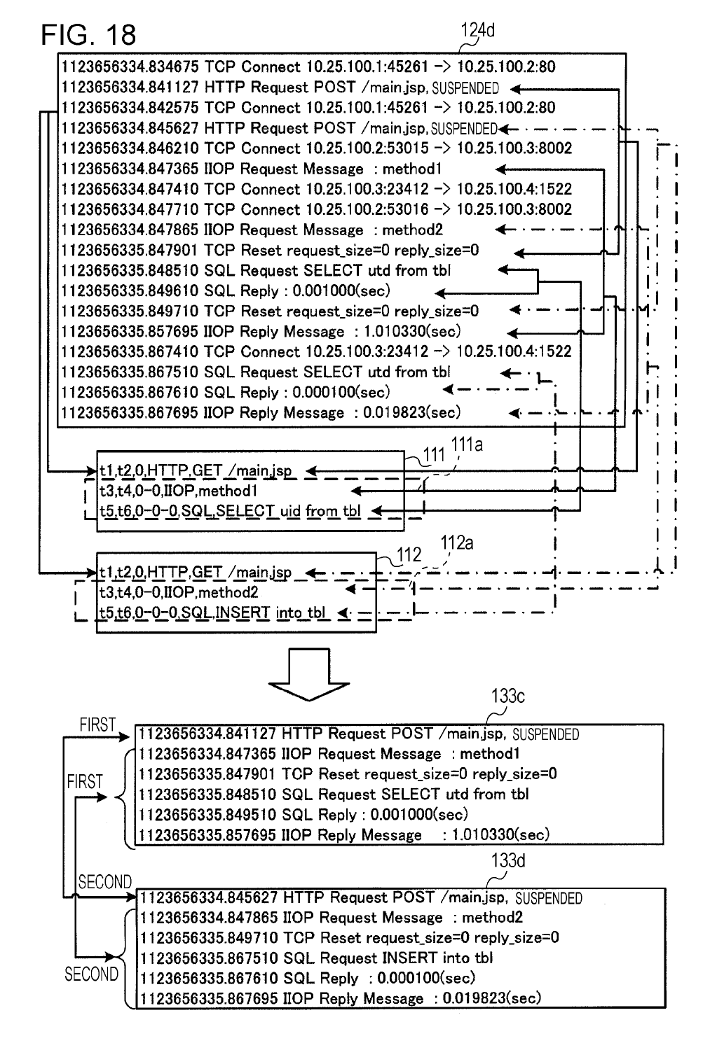

FIG. 18 illustrates the state of the partial matching when multiple suspended processes occur. A message sequence 124d includes two suspended processes. The two suspended processes have the same URL indicated in the respective request messages, and the processing time zones of the two suspended processes are overlapped with each other. Also in this case, the entire matching with the transaction model is performed first. However, since only the transactions that are completed can be detected in the entire matching, the two suspended processes are kept as the target processes.

In the example shown in FIG. 18, the request messages for the suspended processes are the second message data (1123656334.841127 HTTP Request POST/main.jsp, SUSPENDED) and the fourth message data (1123656334.845627 HTTP Request POST/main.jsp, SUSPENDED). The above two messages indicate the same URL “HTTP Request POST/main.jsp”. The partial matching part 132 searches the model storage part 110 by using this URL. As the result of the search, the two transaction models 111 and 112 are detected.

The partial matching part 132 searches the message sequence 124d for the partial transaction information items matching with the partial models 111a and 112a of the transaction models 111 and 112, respectively. In the example shown in FIG. 18, the partial transaction information items matching with the respective partial models 111a and 112a are detected.

It is difficult to uniquely determine the correspondence between the two request messages for the suspended processes and the detected two partial transaction information items. Accordingly, the partial matching part 132 assumes that the request messages for similar processes (having the same URL) are processed in the order in which the request messages are input in the corresponding server, and the calls for other processes are performed in the order of the processing of the request messages. Specifically, the partial matching part 132 arranges the request messages for the suspended processes in time series on the basis of the time stamps. Similarly, the partial matching part 132 arranges the two partial transaction information items detected in the partial matching in time series on the basis of the time stamps of the respective first request messages. The partial matching part 132 sequentially selects one request message from the arrangement of the request messages for the suspended processes in descending order and, at the same time, sequentially selects one information item from the arrangement of the partial transaction information items in descending order. The partial matching part 132 combines the selected request message, the suspension message corresponding to the selected request message, and the selected partial transaction information item with each other. In the combination, the messages are arranged in time series. The partial matching part 132 uses the arrangements of the combined messages as suspended transaction information 133c and suspended transaction information 133d. The suspended transaction information 133c and the suspended transaction information 133d are stored in the suspended-transaction-information storage part 133.

The suspended transaction information is detected in the above manner. The entire matching part 141 performs the entire matching to store the completed transaction information in the completed-transaction-information storage part 142. The analyzing part 151 analyzes the processing status.

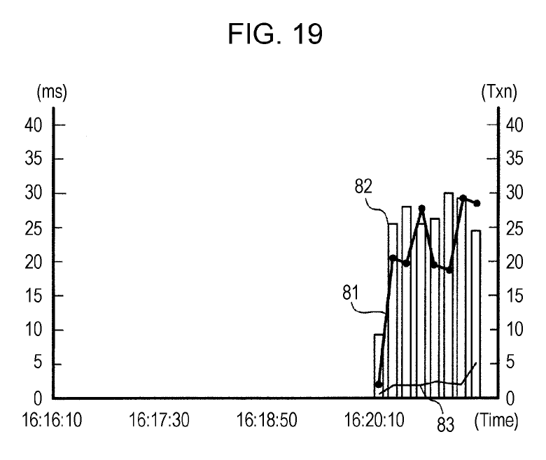

FIG. 19 is a graph showing an example of the result of transaction analysis. A count of completed transactions 81 per unit time within a predetermined time period, a processing time 82, and a count of suspended transactions 83 are shown in the example in FIG. 19. The horizontal axis represents the real time, the left vertical axis represents the processing time, and the right vertical axis represents the count of transactions.

The detection of the suspended transactions allows, for example, the proportion of the suspended transactions to the total count of transactions to be easily calculated. Since it is possible to determine which transaction model the suspended transaction matches with, the processing time of the suspended transaction can be reflected in the calculation of the processing time of the transaction matching with the transaction model for every server. In other words, it is not possible to determine where a delay occurs in the process for which the user presses the “pause” button by the visualization technology in the related art in which only the entire matching is performed, whereas it is possible to accurately determine where a delay occurs in the process for which the user presses the “pause” button according to the present embodiment. Accordingly, it is possible to determine the status of the system and to appropriately respond to the determined status, thus reducing the times of failure and delay. As a result, it is possible to prevent decrease in the satisfaction level of customers.

For example, it is assumed that the user cannot wait for a response and suspends the processing because it takes a longer time to execute the process corresponding to “IIOP method1” in the application server 42 in the suspended transaction shown in FIG. 8. In this case, only the detection of the completed transaction as in the related art does not allow the case in which it takes longer to execute the process corresponding to the “IIOP method1” to be detected. In contrast, according to the present embodiment, the suspended transaction shown in FIG. 8 can be detected as an example of the case in which it takes a longer time to execute the process corresponding to “IIOP method1”.

The processing functions described above can be realized by a computer. In this case, programs describing the processing content of the functions of the service-processing-status analyzing apparatus are provided. The computer executes the programs to realize the above functions. The programs describing the processing content can be recorded in a computer-readable recording medium. The computer-readable recording medium is, for example, a magnetic recording device, an optical disk, a magneto-optical recording medium, or a semiconductor memory. The magnetic recording device is, for example, an HDD, a flexible disk (FD), or a magnetic tape (MT). The optical disk is, for example, a digital versatile disk (DVD), a DVD-RAM, a compact disk-read only memory (CD-ROM), a compact disk-recordable(CD-R), or a compact-disk-rewritable (CD-RW). The magneto-optical recording medium is, for example, a magneto-optical disk (MO).

In order to distribute the above programs, for example, a portable recording medium, such as a DVD or a CD-ROM, on which the programs are recorded is on sale. The programs may be stored in a server computer and may be transferred from the server computer to another computer over a network.

The computer executing the above programs stores the programs recorded on the portable recording medium or transferred from the server computer in its device. The computer reads out the programs from the own storage device to execute the processing in accordance with the programs. The computer may directly read out the programs from the portable recording medium to execute the processing in accordance with the programs. Alternatively, the computer may sequentially execute the processing in accordance with a program that is received each time the program is transferred from the server computer.

It should be understood by those skilled in the art that various modifications, combinations, sub-combinations and alterations may occur depending on design requirements and other factors insofar as they are within the scope of the appended claims or the equivalents thereof.

What is claimed is:

1. A computer-readable recording medium on which a service-processing-status analyzing program is recorded, the service-processing-status analyzing program causing a computer to analyze a service processing status of a network system in which a plurality of servers are connected to each other, the program causing the computer to function as:
unit which collects messages exchanged over a network and storing information about the collected messages in message storage means;
unit which searches the information about the messages stored in the message storage means for a suspension message to request suspension of a process, to detect a request message for the process suspended by the suspension message as a suspended process request message;
unit which refers to model storage means storing a transaction model indicating the arrangement of messages exchanged in a plurality of processes executing each transaction, to search for the transaction model beginning with a message having the same content as that of the detected suspended process request message, and generates a partial model resulting from exclusion of the messages corresponding to the suspended process request message and the suspension message from the detected transaction model;
unit which extracts a plurality of messages composing the arrangement of messages similar to that of the created partial model from the messages exchanged after the suspended process request message in the message storage means, to generate partial transaction information composed of the extracted messages; and
unit which combines the generated partial transaction information with at least the suspended process request message to generate suspended transaction information, and stores the generated suspended transaction information in suspended-transaction-information storage means.

2. The computer-readable recording medium on which the service-processing-status analyzing program is recorded according to claim 1,
wherein the partial transaction information is generated by using the request message exchanged within a time zone from the exchange time of the suspended process request message to the exchange time of the suspension message as a first message.

3. The computer-readable recording medium on which the service-processing-status analyzing program is recorded according to claim 1,
wherein, if a plurality of transaction models beginning with a message having the same content as that of the suspended process request message is detected, the partial models are generated for the plurality of detected transaction models, and
wherein the partial transaction information matching with either of the plurality of generated partial models is generated when the plurality of transaction models are generated.

4. The computer-readable recording medium on which the service-processing-status analyzing program is recorded according to claim 1,
wherein, if a plurality of suspended process request messages in which the time zones of the suspended process are overlapped with each other are detected and a plurality of partial transaction information items are generated, the plurality of suspended process request messages are arranged in time series on the basis of the exchange times thereof, the plurality of partial transaction information items are arranged in time series on the basis of the exchange times of the respective first messages thereof, and the plurality of suspended process request messages are combined with the partial transaction information items one by one in descending order in time series to generate a plurality of suspended transaction information items.

5. The computer-readable recording medium on which the service-processing-status analyzing program is recorded according to claim 1, the program further causing the computer to function as:
unit which extracts a plurality of messages composing the arrangement of messages similar to that of the transaction model stored in the model storage means from the message storage means to generate completed transaction information composed of the extracted messages, and storing the completed transaction information in completed-transaction-information storage means.

6. The computer-readable recording medium on which the service-processing-status analyzing program is recorded according to claim 5,
wherein the partial transaction information is composed of the messages that are not included in the completed transaction information that is generated, among the messages stored in the message storage means.

7. The computer-readable recording medium on which the service-processing-status analyzing program is recorded according to claim 1, the program further causing the computer to function as:
unit which counts the number of suspended transactions per unit time on the basis of the suspended transaction information stored in the suspended-transaction-information storage means, and displaying the result of the counting.

8. The computer-readable recording medium on which the service-processing-status analyzing program is recorded according to claim 7, the program further causing the computer to function as:
unit which extracts a plurality of messages composing the arrangement of messages similar to that of the transaction model stored in the model storage means from the message storage means to generate completed transaction information composed of the extracted messages, and stores the completed transaction information in completed-transaction-information storage means,
wherein the number of suspended transactions per unit time is counted on the basis of the suspended transaction information stored in the suspended-transaction-information storage means, the number of completed transactions per unit time is counted on the basis of the completed transaction information stored in the completed-transaction-information storage means, and the number of suspended transactions is compared with the number of completed transactions to display an image indicating the comparison result.

9. The computer-readable recording medium on which the service-processing-status analyzing program is recorded according to claim 1,
wherein the partial transaction information, the suspended process request message, and the suspension message are combined with each other to generate the suspended transaction information.

10. A service-processing-status analyzing apparatus analyzing a service processing status of a network system in which a plurality of servers are connected to each other, the apparatus comprising:
message storage means;
message observing unit which collects messages exchanged over a network and storing information about the collected messages in the message storage means;
suspension detecting unit which searches the information about the messages stored in the message storage means for a suspension message to request suspension of a process to detect the request message for the process suspended by the suspension message as a suspended process request message;
model storage means for storing a transaction model indicating the arrangement of messages exchanged in a plurality of processes executing each transaction;
partial model creating unit which refers to the model storage means to search for the transaction model beginning with a message having the same content as that of the suspended process request message detected by the suspension detecting unit, and generating a partial model resulting from exclusion of the messages corresponding to the suspended process request message and the suspension message from the detected transaction model;
partial-transaction-information generating unit which extracts a plurality of messages composing the arrangement of messages similar to that of the partial model created by the partial model creating unit from the messages exchanged after the suspended process request message in the message storage means, to generate partial transaction information composed of the extracted messages;
suspended-transaction-information storage means; and
suspended-transaction-information generating unit which combines the partial transaction information generated by the partial-transaction-information generating unit with at least the suspended process request message to generate suspended transaction information and storing the generated suspended transaction information in the suspended-transaction-information storage means.

11. A method of analyzing a service processing status of a network system in which a plurality of servers are connected to each other, the method comprising:
collecting messages exchanged over a network and storing information about the collected messages in message storage means;
searching the information about the messages stored in the message storage means for a suspension message to request suspension of a process to detect the request message for the process suspended by the suspension message as a suspended process request message;
referring to model storage means storing a transaction model indicating the arrangement of messages exchanged in a plurality of processes executing each transaction to search for the transaction model beginning with a message having the same content as that of the detected suspended process request message, and generating a partial model resulting from exclusion of the messages corresponding to the suspended process request message and the suspension message from the detected transaction model;
extracting a plurality of messages composing the arrangement of messages similar to that of the created partial model from the messages exchanged after the suspended process request message in the message storage means to generate partial transaction information composed of the extracted messages; and
combining the generated partial transaction information with at least the suspended process request message to generate suspended transaction information, and storing the generated suspended transaction information in suspended-transaction-information storage means.
